(19) United States
(12) Patent Application Publication
(10) Pub. No.: US 2026/0200736 A1
(43) Pub. Date: Jul. 16, 2026

(54) OLIVINE-BASED CATHODE ACTIVE MATERIAL FOR LITHIUM SECONDARY BATTERY AND METHOD FOR PREPARING SAME

(71) Applicant: RESEARCH INSTITUTE OF INDUSTRIAL SCIENCE & TECHNOLOGY, Pohang-si (KR)

(72) Inventors: Sang Cheol NAM, Seoul (KR); Jong ll PARK, Pohang-si (KR)

(21) Appl. No.: 19/133,857

(22) PCT Filed: Dec. 26, 2022
(86) PCT No.: PCT/KR2022/021272

§ 371 Date: May 29, 2025

(30) Foreign Application Priority Data
Dec. 23, 2022 (KR) 10-2022-0182881

(51) Int. Cl. C01B 25/45

(52) U.S. Cl. CPC C01B 25/45; C01P 2004/03; C01P 2004/04; C01P 2004/50; C01P 2004/61; C01P 2004/62; C01P 2004/86; C01P 2006/11; C01P 2006/12; C01P 2006/40

(57) ABSTRACT

The embodiments relate to an olivine-based positive electrode active material for a lithium secondary battery and a method for manufacturing the same. The embodiments relate to an olivine-based positive electrode active material for a lithium secondary battery and a method for manufacturing the same.

$$13. < C \% * BET / m < 40. \qquad [ Relational Expression 1 ]$$

In Relational Expression 1, C % is a weight percentage (%) of the carbon coating layer, BET is a specific surface area of the olivine-based positive electrode active material for a lithium secondary battery, and m is a tap density of the olivine-based positive electrode active material for a lithium secondary battery.

### TECHNICAL FIELD

The present embodiments relate to an olivine-based positive electrode active material for a lithium secondary battery, a method for manufacturing the same, and a lithium secondary battery including the same.

### BACKGROUND ART

As the electric vehicle market expands, the market for positive electrode active materials, which account for 40% or more of the cost of lithium-ion batteries, is also growing rapidly each year. Automobiles are classified into six segments based on overall length thereof, with the A-segment for vehicles measuring 3,500 mm or less and the F-segment for vehicles measuring 5,000 mm or more. Accordingly, electric vehicles that use batteries also employ different positive electrode active materials depending on classes and traveling ranges thereof. For electric vehicles with a traveling range of 600 km or more per a single charge, lithium-ion batteries with a high energy density are required, so high-nickel NCM-based positive electrode active materials should be used. In contrast, mid-Ni NCM-based materials are used for electric vehicles with a traveling range of around 400 km. However, for electric vehicles that do not require a long traveling range and are relatively inexpensive, it is advantageous in terms of cost to use materials that do not have a high energy density but are safe and have a long life. Lithium iron phosphate positive electrode active materials are materials with an olivine structure composed of FeO6 octahedral sites and PO4 tetrahedral sites, in which lithium ions are intercalated and deintercalated through a one-dimensional pathway. The materials include Li, Fe, and P as their main composition, and thus have a cost advantage due to the lower expense of metal minerals compared to NCA or NCM materials, which mainly use Ni and Co. In addition, the structure is stable due to the strong P—O bond, so there is no oxygen dissociation at high temperatures during charging, thereby exhibiting excellent thermal stability. In addition, the materials have excellent life characteristics, so many electric vehicles using the materials have been produced in China. However, since intercalation and deintercalation of lithium ions occur through one-dimensional diffusion, the particles should be manufactured in nano size. In addition, there is a drawback in that a uniform carbon coating should be applied to the surface of the material because the material itself has no electrical conductivity. Nevertheless, in recent electric vehicles, as high safety is being emphasized and cell to pack and even cell to chassis technologies are being actively developed, the difference in energy density compared to NCM-based batteries of the related art is gradually narrowing.

Lithium iron phosphate (LFP) is generally known to be manufactured by a hydrothermal synthesis method using LiOH, FeSO₄, and (NH₄)₃PO₄; a spray-drying method using Li₂CO₃ and FePO₄ as precursors; or a milling method in which Li₂CO₃ and FePO₄ are prepared by milling. However, the above manufacturing methods have problems, such as complicated processes, generation of a large amount of wastewater or secondary pollutants, complicated treatment processes of wastewater or secondary pollutants, and low overall economic feasibility.

Therefore, there is a need to develop a lithium iron phosphate (LFP) with excellent electrochemical performance and a method for environmentally friendly and economically manufacturing the same.

The present invention relates to a method for manufacturing an olivine-based LFP positive electrode active material for a lithium secondary battery in which Li₃PO₄, which is an intermediate material generated in a process for manufacturing lithium hydroxide starting from brine, and Li₃PO, which is a form of lithium recovered from waste lithium-ion batteries, are used as lithium raw materials, and Fe₂O₃, which is manufactured in an oxide form by neutralization and precipitation of a pickling washing solution discharged after surface cleaning of steel materials in the steel industry, is used as an iron (Fe) raw material, and to an olivine-based LFP positive electrode active material for a lithium secondary battery manufactured using the same.

### DISCLOSURE

### Technical Problem

An embodiment of the present invention attempts to provide an olivine-based positive electrode active material for a lithium secondary battery, a surface of the active material being uniformly coated with carbon.

Another embodiment of the present invention attempts to provide a method for economically and environmentally friendly manufacturing an olivine-based positive electrode active material for a lithium secondary battery using a spray-drying process.

### Technical Solution

An olivine-based positive electrode active material for a lithium secondary battery according to an embodiment of the present invention includes a core portion; and a carbon coating layer positioned on a surface of the core portion, wherein Relational Expression 1 is satisfied,

$$13. < C \% \times BET / m < 40. \qquad [ Relational Expression 1 ]$$

In Relational Expression 1, C % is a weight percentage (%) of the carbon coating layer, BET is a specific surface area of the olivine-based positive electrode active material for a lithium secondary battery, and m is a tap density of the olivine-based positive electrode active material for a lithium secondary battery.

Note that, the core portion may be represented by Chemical Formula 1,

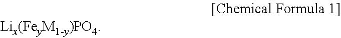

Where 0.9≤x≤1.3, 0.89≤y≤1.34, 0.99≤x/y≤1.03.

In addition, the carbon coating layer may be included in a range of 1.0 wt % to 2.5 wt % based on a total weight of the core portion and the carbon coating layer, and may have an average thickness in a range of 5 nm to 15 nm.

The specific surface area of the olivine-based positive electrode active material for a lithium secondary battery may be in a range of 10.0 m²/g to 30.0 m²/g, and the tap density may be in a range of 1.0 g/cm³ to 1.15 g/cm³.

The olivine-based positive electrode active material for a lithium secondary battery may include secondary particles formed by agglomeration of primary particles having an average particle size (D50) in a range of 100 nm to 200 nm, and an average particle size (D50) of the secondary particles may be in a range of 1.0 μm to 3.0 μm.

A method for manufacturing an olivine-based positive electrode active material for a lithium secondary battery according to another embodiment of the present invention includes: mixing and milling lithium dihydrogen phosphate (LiH2PO4), ferric oxide (Fe2O3), a carbon additive, a dispersant, and a solvent to obtain a slurry; spray-drying the slurry to obtain a positive electrode active material precursor; and firing the positive electrode active material precursor in a reducing atmosphere to obtain an olivine-based positive electrode active material with a carbon coating layer.

In the firing the positive electrode active material precursor in a reducing atmosphere to obtain an olivine-based positive electrode active material with a carbon coating layer, an olivine-based positive electrode active material satisfying Relational Expression 1 may be obtained,

$$13. < C \% \times BET / m < 40. \qquad [ Relational Expression 1 ]$$

In Relational Expression 1, C % is a weight percentage (%) of the carbon coating layer, BET is a specific surface area of the olivine-based positive electrode active material for a lithium secondary battery, and m is a tap density of the olivine-based positive electrode active material for a lithium secondary battery.

In the mixing and milling lithium dihydrogen phosphate (LiH₂PO₄), ferric oxide (Fe₂O₃), a carbon additive, a dispersant, and a solvent to obtain a slurry, the lithium dihydrogen phosphate (LiH₂PO₄) may be mixed in a molar ratio ranging from 1.0 to 4.0 relative to the ferric oxide (Fe₂O₃), and an average particle size (D50) of ferric oxide (Fe₂O₃) in the obtained slurry may be in a range of 500 nm to 1 μm.

The carbon additive may be one or more selected from glucose, sucrose, fructose, lactose, and maltose, and may be mixed in a range of 9 wt % to 13 wt % based on a weight of the ferric oxide (Fe₂O₃).

In addition, the dispersant may be one or more selected from citric acid, fumaric acid, adipic acid, succinic acid, tartaric acid, glutaric acid, maleic acid, oxalic acid, malonic acid, and ascorbic acid.

In addition, the dispersant may be mixed in a range of 4 wt % to 6 wt % based on a weight of the ferric oxide (Fe₂O₃).

The method may further include, after the firing the positive electrode active material precursor in a reducing atmosphere to obtain an olivine-based positive electrode active material with a carbon coating layer, mixing the obtained olivine-based positive electrode active material with a carbon additive and firing the mixture in the reducing atmosphere.

### Advantageous Effects

According to an embodiment of the present invention, an olivine-based positive electrode active material for a lithium secondary battery can be provided which has carbon uniformly coated on the surface, thereby making it possible to improve the performance of a lithium secondary battery.

According to another embodiment of the present invention, a method for manufacturing an olivine-based positive electrode active material for a lithium secondary battery, which involves simple processes, is environmentally friendly, and generates less wastewater, can be provided.

### DESCRIPTION OF THE DRAWINGS

FIG. 1 is a schematic diagram of an olivine-based positive electrode active material for a lithium secondary battery according to an embodiment of the present invention.

FIG. 2 schematically illustrates a manufacturing process of an olivine-based positive electrode active material for a lithium secondary battery according to another embodiment of the present invention.

FIG. 3 shows a surface SEM image of an olivine-based positive electrode active material for a lithium secondary battery according to Example 1 of the present invention.

FIG. 4 shows results of FIB-SEM analysis of the olivine-based positive electrode active material for a lithium secondary battery according to Example 1 of the present invention.

FIG. 5 shows results of TEM analysis of the olivine-based positive electrode active material for a lithium secondary battery according to Example 1 of the present invention.

### DETAILED DESCRIPTION OF THE EMBODIMENTS

In the description of the present invention, the terms such as first, second, and third are used to describe, but are not limited to, various parts, components, regions, layers, and/or sections. These terms are used only to discriminate one part, component, region, layer or section from another part, component, region, layer or section. Therefore, a first part, component, region, layer or section described below may be referred to as a second part, component, region, layer or section without departing from the scope of the present invention.

The technical terms used herein are set forth only to mention specific embodiments and are not intended to limit the present invention. Singular forms used herein are intended to include the plural forms as long as phrases do not clearly indicate an opposite meaning. In the present specification, the term “including (comprising)” is intended to embody specific characteristics, regions, integers, steps, operations, elements and/or components, but is not intended to exclude presence or addition of other characteristics, regions, integers, steps, operations, elements, and/or components.

Unless otherwise defined, all terms including technical and scientific terms used herein have the same meanings as the meanings generally understood by one skilled in the art to which the present invention pertains. Terms, such as those defined in commonly used dictionaries, are to be interpreted as having meanings consistent with the relevant technical literature and the present disclosure, and are not to be interpreted as having idealized or overly formal meanings unless expressly so defined herein.

Hereinafter, examples of the present invention will be described in detail. However, the Examples are only provided by way of example, and the present invention is not limited thereto, but is only defined by the scope of the claims described later.

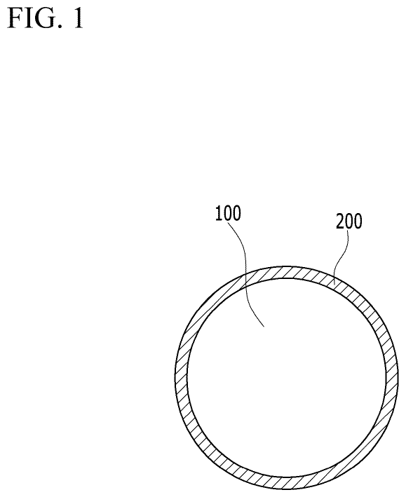

FIG. 1 is a schematic diagram of an olivine-based positive electrode active material for a lithium secondary battery according to an embodiment of the present invention.

Referring to FIG. 1, an olivine-based positive electrode active material for a lithium secondary battery according to the present embodiment may include a core portion 100 and a carbon coating layer 200 positioned on a surface of the core portion.

The core portion 100 may be represented by the following chemical formula 1.

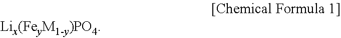

Where 0.9≤x≤1.3, 0.89≤y≤1.34, 0.99≤x/y≤1.03.

In Chemical Formula 1, M may be one or more selected from Mn, Co, Ni, Cu, Zn, Mg, Cr, V, Mo, Ti, Al, Nb, B, or Ga, and the type and content thereof are not particularly limited as long as the performance of a lithium secondary battery can be improved.

Note that the core portion 100 can be specifically represented by the following chemical formula 2.

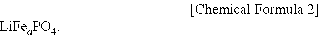

Where 0.99≤a≤1.03.

The coating layer 200 may be uniformly positioned on the surface of the core portion 100, and specifically, may be positioned in an average thickness range of 5 nm to 15 nm, and more specifically, 5 nm to 10 nm. Note that carbon in the carbon coating layer 200 may be included in a range of 1.0 wt % to 2.5 wt % based on a total weight of the core portion 100 and the carbon coating layer 200. When the carbon coating layer is within the specific thickness range and/or includes the carbon within the specific weight range, it is advantageous in improving the charge/discharge capacity of a lithium secondary battery and preventing detachment from a current collector during manufacture of an electrode plate.

The olivine-based positive electrode active material for a lithium secondary battery according to an embodiment of the present invention may have a specific surface area in a range of 10 m²/g to 30.0 m²/g, specifically 10 m²/g to 20.0 m²/g, and more specifically 12.2 m²/g to 17.5 m²/g. In addition, the olivine-based positive electrode active material for a lithium secondary battery according to an embodiment of the present invention may have a tap density in a range of 1.0 g/cm³ to 1.15 g/cm³. When the specific surface area and tap density of the olivine-based positive electrode active material for a lithium secondary battery are within the specific ranges, it is advantageous in improving the charge/discharge capacity of a lithium secondary battery while maintaining stability and thereby increasing the life.

Note that the olivine-based positive electrode active material for a lithium secondary battery according to an embodiment of the present invention may satisfy the following Relational Expression 1.

$$13. < C \% \times BET / m < 40. \qquad [ Relational Expression 1 ]$$

In Relational Expression 1, C % is a weight percentage (%) of the carbon coating layer, BET is a specific surface area of the olivine-based positive electrode active material for a lithium secondary battery, and m is a tap density of the olivine-based positive electrode active material for a lithium secondary battery.

Note that the olivine-based positive electrode active material for a lithium secondary battery according to an embodiment of the present invention may include secondary particles formed by agglomeration of primary particles including the core portion 100 and the carbon coating layer 200 positioned on the surface of the core portion.

An average particle size (D50) of the primary particles may be in a range of 50 nm to 400 nm, specifically 100 nm to 200 nm, and more specifically 150 nm to 170 nm.

In addition, an average particle size (D50) of the secondary particles may be in a range of 1.0 μm to 5.0 μm, and specifically 1.0 μm to 3.0 μm.

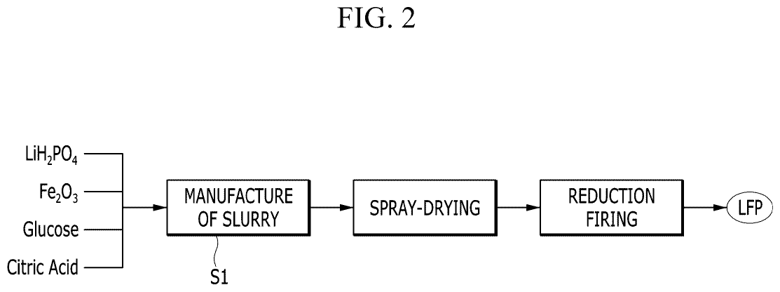

FIG. 2 schematically illustrates a method for manufacturing an olivine-based positive electrode active material for a lithium secondary battery according to another embodiment of the present invention.

Referring to FIG. 2, the method for manufacturing an olivine-based positive electrode active material for a lithium secondary battery according to another embodiment of the present invention may include a step of manufacturing a slurry including main raw materials (S1), a step of spray-drying the slurry (S2), and a reduction firing step (S3).

First, the step (S1) of manufacturing a slurry including main raw materials is performed.

In the present embodiment, an iron (Fe) raw material, a lithium (Li) raw material, a phosphorus (P) raw material, a carbon (C) raw material, and a dispersant are mixed in a solvent, and the mixture is then milled for 4 hours or longer using a wet milling method to manufacture a slurry. A final slurry concentration manufactured it this case may be in a range of 20 wt % to 40 wt % based on the solid content. When the concentration of the slurry is within the specific range, it is advantageous in manufacturing an olivine-based positive electrode active material for a lithium secondary battery with excellent quality.

In the present invention, the iron (Fe) raw material may be iron (Fe) oxide, and specifically, ferric oxide (Fe₂O₃). For the iron (Fe) oxide, specifically, ferric oxide (Fe₂O₃) recovered from a steel pickling waste liquid may be used, which has the advantage of reducing the production cost of an olivine-based positive electrode active material for a lithium secondary battery and improving the overall economic feasibility. In addition, an average particle size (D50) of ferric oxide (Fe₂O₃) in the finally obtained slurry may be in a range of 500 nm to 1 μm. When the average particle size (D50) of ferric oxide (Fe₂O₃) in the slurry falls within the specific range, it is advantageous in manufacturing an olivine-based positive electrode active material for a lithium secondary battery intended in the present invention.

The lithium (Li) raw material and phosphorus (P) raw material may be lithium dihydrogen phosphate (LiH₂PO₄). Specifically, the lithium dihydrogen phosphate (LiH₂PO₄) may be obtained by reacting lithium phosphate (Li₃PO₄), which is an intermediate product generated in a process of producing lithium carbonate or lithium hydroxide from salt lakes, with a phosphoric acid (H₃PO₄) solution. The lithium dihydrogen phosphate (LiH₂PO₄) may be mixed in a molar ratio ranging from 1.0 to 4.0, specifically from 2.0 to 3.0 relative to the ferric oxide (Fe₂O₃).

The carbon (C) additive may be one or more selected from glucose, sucrose, fructose, lactose, and maltose. The carbon additive may be mixed in a range of 9 wt % to 13 wt % based on a weight of the ferric oxide (Fe₂O₃).

Note that the dispersant may be one or more selected from citric acid, fumaric acid, adipic acid, succinic acid, tartaric acid, glutaric acid, maleic acid, oxalic acid, malonic acid, and ascorbic acid, and may be mixed in a range of 4 wt % to 6 wt % based on the weight of the ferric oxide (Fe₂O₃). By mixing the dispersant, the raw materials in the slurry are uniformly dispersed, which is advantageous in manufacturing an olivine-based positive electrode active material for a lithium secondary battery with excellent quality.

Next, the slurry is spray-dried to manufacture a positive electrode active material precursor.

The step of spray-drying the slurry to obtain a positive electrode active material precursor may be performed under the conditions of a hot air temperature of 250° C. to 300° C. and an exhaust hot air temperature of 100° C. to 150° C. Through the spray-drying, a positive electrode active material precursor having an average particle size in a range of about 3 μm to 10 μm may be obtained.

Next, the positive electrode active material precursor is fired to manufacture an olivine-based positive electrode active material for a lithium secondary battery.

The step of firing the positive electrode active material precursor in a reducing atmosphere to obtain an olivine-based positive electrode active material for a lithium secondary battery having a carbon coating layer may involve loading the obtained positive electrode active material precursor into a kiln and then firing the material under high temperature conditions for a predetermined time in an atmosphere in which an inert gas is continuously supplied, thereby manufacturing an olivine-based positive electrode active material for a lithium secondary battery. After the firing is completed, the material may be cooled and then subjected to a pulverizing process using a jet mill, resulting in the manufacture of a final olivine-based positive electrode active material for a lithium secondary battery having an average particle size (D50) of about 1 μm to 3 μm.

On the other hand, the olivine-based positive electrode active material for a lithium secondary battery obtained above may be wet-mixed with the carbon additive and loaded into a kiln, heated at a high temperature for a predetermined time in an atmosphere in which an inert gas is continuously supplied, and then subjected to pulverization and firing, resulting in the manufacture of a final olivine-based positive electrode active material for a lithium secondary battery.

In this case, the description of the obtained olivine-based positive electrode active material for a lithium secondary battery is omitted as it has been specifically described above.

### MODE FOR INVENTION

Hereinafter, Examples of the present invention will be described in detail. However, the Examples are only provided by way of example, and the present invention is not limited thereto, but is only defined by the scope of the claims described later.

### Example 1

A LiH₂PO₄ powder obtained by reacting a H₃PO₄ solution with Li₃PO₄ and then drying the resulting product was used as an LFP raw material. A slurry was prepared by adding Fe₂O₃ powder (>2N5), citric acid as a dispersant, and glucose as a carbon coating source to LiH₂PO₄, followed by wet milling for 4 hours or more. In this case, water was used as a solvent.

Note that LiH₂PO₄, Fe₂O₃, citric acid, and glucose were mixed in a weight ratio of 1:0.77:0.037:0.07.

The slurry was continuously fed into a spray-drying apparatus to prepare LFP precursor particles with an average particle size ranging from about 3 to 10 μm. 10 g of the prepared LFP precursor was weighted into an Al₂O₃ crucible, and placed in a tube furnace, and subjected to reduction firing at 550° C. to 750° C. for 8 hours while flowing N2 gas at a rate of 1 L/min. The positive electrode active material fired in this way was then pulverized to a size of 1 to 3 μm using a jet mill process again, followed by addition of glucose, wet homogeneous mixing, and reduction firing at 550° C. to 750° C. for 4 hours in a tube furnace while flowing N2 gas at a rate of 1 L/min. Afterwards, through a pulverization process, an olivine-based positive electrode active material powder for a lithium secondary battery with a final average particle diameter (D50) of about 1 to 3 μm was prepared.

The chemical formula for the overall preparation process is as follows:

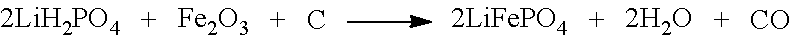

The Li/Fe ratio measured by ICP method analysis on the olivine-based positive electrode active material for a lithium secondary battery according to Example 1 was 1.02, and the final carbon content measured by C/S analysis method was confirmed to be 1.2 wt %.

### Examples 2 to 5

With the same method as in Example 1, olivine-based positive electrode active materials for a lithium secondary battery having a Li/Fe ratio of 1.02 and carbon contents of 1.7 wt % and 2.4 wt %, and olivine-based positive electrode active materials for a lithium secondary battery having a carbon content of 1.2 wt % and Li/Fe ratios of 0.99 and 1.03, respectively, were prepared.

### Comparative Examples 1 to 4

With the same method as in Example 1, olivine-based positive electrode active materials for a lithium secondary battery having a Li/Fe ratio of 1.02 and carbon contents of 0.9 wt % and 3 wt %, and olivine-based positive electrode active materials for a lithium secondary battery having a carbon content of 1.2 wt % and Li/Fe ratios of 0.97 and 1.05, respectively, were prepared.

The amounts of raw materials used for preparing the olivine-based positive electrode active materials for a lithium secondary battery according to Examples 1 to 5 and Comparative Examples 1 to 4 are summarized in Table 1, and the physical properties of the prepared olivine-based positive electrode active materials for a lithium secondary battery are summarized in Table 2 below.

TABLE 1

| | Raw materials | | | |
|---|---|---|---|---|
| | LiH₂PO₄ | Fe₂O₃ | Citric | Glucose |
| | (g) | (g) | Acid (g) | (g) |
| Example 1 | 130 | 100 | 4.8 | 9.1 |
| Example 2 | 130 | 100 | 4.8 | 11.2 |
| Example 3 | 130 | 100 | 4.8 | 13.3 |
| Comparative Example 1 | 130 | 100 | 4.8 | 7.2 |
| Comparative Example 2 | 130 | 100 | 4.8 | 15.6 |
| Example 4 | 120 | 100 | 4.8 | 9.1 |
| Example 5 | 135 | 100 | 4.8 | 9.1 |
| Comparative Example 3 | 112 | 100 | 4.8 | 9.1 |
| Comparative Example 4 | 145 | 100 | 4.8 | 9.1 |

The BET, tap density, and primary particle size of the olivine-based positive electrode active materials for a lithium secondary battery according to Examples 1 to 5 and Comparative Examples 1 to 4 were measured and are summarized in Table 2 below.

In the present invention, the carbon content was measured by the C/S analysis method of measuring carbon and sulfur contained in inorganic substances using infrared absorption.

The BET was measured using a Tristar II BET analyzer after removing moisture as much as possible under vacuum conditions.

The tap density was measured using a tap density measuring device after 3,000 tappings.

The primary particle size was measured using an SEM image obtained from FIB cross-sectional analysis. The average particle size (D50) of the primary particles can be calculated as the average value of the particle sizes of to 30 primary particles located consecutively adjacent to each other among the primary particles included in a 1 μm×1 μm area of the SEM image at 10,000× magnification, obtained from the FIB cross-sectional analysis.

TABLE 2

| | | | | | Primary | Secondary | [Relational |
|---|---|---|---|---|---|---|---|
| | | Carbon | | Tap | particle | particle | Expression 1] |
| | | content | BET | density | Size | size | C % × BET/ |
| | Li/Fe | (%) | (m²/g) | (g/cc) | (nm) | (um) | tap density |
| Example 1 | 1.02 | 1.2 | 12.2 | 1.12 | 157 | 2.3 | 13.07 |
| Example 2 | 1.02 | 1.7 | 15.7 | 1.11 | 155 | 2.5 | 24.05 |
| Example 3 | 1.02 | 2.4 | 17.2 | 1.10 | 170 | 2.7 | 37.53 |
| Comparative | 1.02 | 0.9 | 10.1 | 1.15 | 140 | 1.9 | 7.90 |
| Example 1 | | | | | | | |
| Comparative | 1.02 | 3.0 | 30.2 | 0.94 | 168 | 3.1 | 96.39 |
| Example 2 | | | | | | | |
| Example 4 | 0.99 | 1.2 | 12.5 | 1.15 | 150 | 2.5 | 13.04 |
| Example 5 | 1.03 | 1.2 | 12.8 | 1.14 | 152 | 2.3 | 13.47 |
| Comparative | 0.97 | 1.2 | 11.9 | 1.13 | 145.2 | 2.2 | 12.64 |
| Example 3 | | | | | | | |
| Comparative | 1.05 | 1.2 | 12.1 | 1.14 | 170.2 | 4.2 | 12.74 |
| Example 4 | | | | | | | |

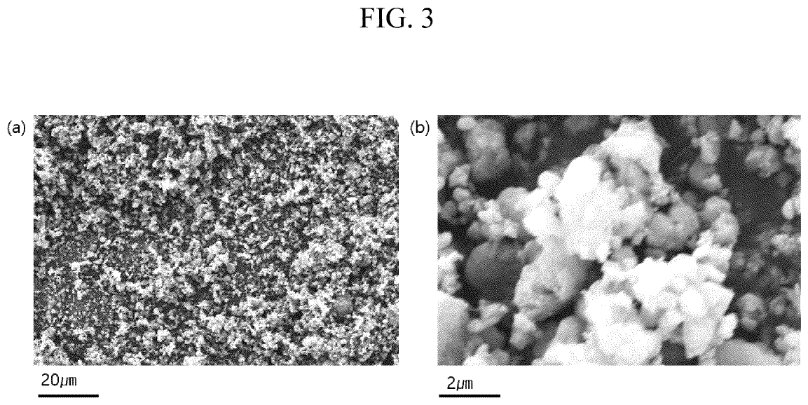

FIG. 3 shows a surface SEM image of an olivine-based positive electrode active material for a lithium secondary battery according to Example 1 of the present invention.

The surface of the olivine-based positive electrode active material for a lithium secondary battery according to Example 1 was analyzed using a SEM (scanning electron microscope, JEOL JSM-6610), and the result is shown in FIG. 3. Specifically, FIG. 3(a) shows a SEM image at 1000× magnification, and FIG. 3(b) shows a SEM image at 10,000× magnification. Referring to FIG. 3, it can be confirmed that the positive electrode active material according to Example 1 was prepared as a powder of an olivine-based positive electrode active material for a lithium secondary battery having a final average particle size (D50) of 1 to 3 um.

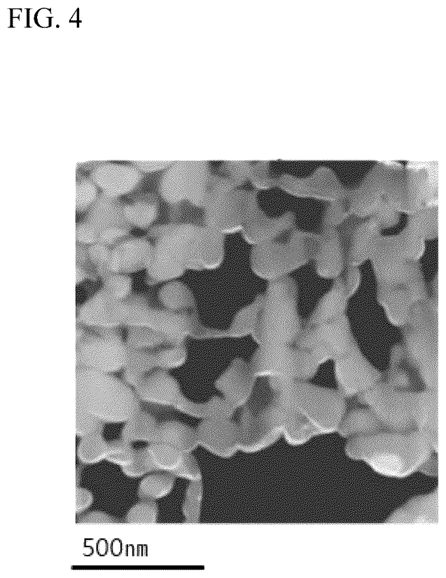

FIG. 4 shows results of FIB-SEM analysis of the olivine-based positive electrode active material for a lithium secondary battery according to Example 1 of the present invention.

Referring to FIG. 4, it can be confirmed that, for the olivine-based positive electrode active material for a lithium secondary battery according to Example 1, after cross-sectioning was performed using FIB (Focused Ion Beam, SEIKO 3050SE), and SEM (Scanning Electron Microscope, JEOL JSM-6610) analysis was conducted, the primary particles are found to have particle diameters distributed in the range of 50 nm to 400 nm. Note that it can be confirmed that the primary particles are uniformly coated with carbon, thereby forming a smooth surface.

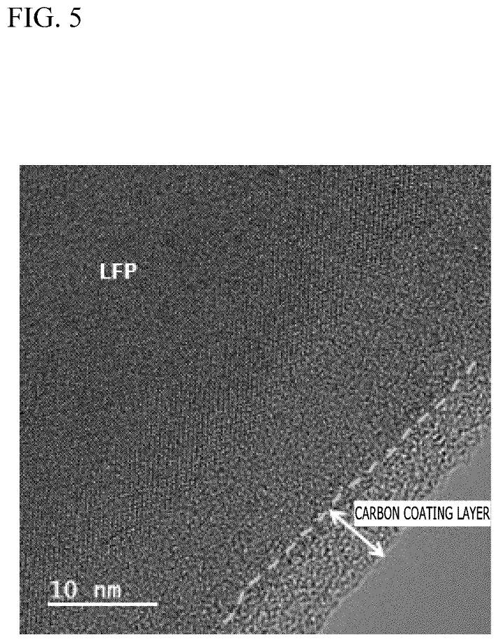

FIG. 5 shows results of TEM analysis of the olivine-based positive electrode active material for a lithium secondary battery according to Example 1 of the present invention.

The olivine-based positive electrode active material for a lithium secondary battery according to Example 1 was analyzed using a TEM (Transmission Electron Microscope, JEOL 2100F) analysis device after cross-sectioning was performed using FIB (Focused Ion Beam, SEIKO 3050SE).

Referring to FIG. 5, it can be confirmed that the olivine-based positive electrode active material for a lithium secondary battery is uniformly coated with amorphous carbon and has a thickness of about 5 nm to 8 nm.

### (Preparation of Coin-Type Half-Cell)

CR2032 coin cells were prepared using the olivine-based positive electrode active materials prepared according to the Examples and Comparative Examples, and then subjected to electrochemical evaluation. The results are summarized in Table 2 below.

Specifically, a slurry for electrode plate preparation was prepared by mixing the olivine-based positive electrode active material for a lithium secondary battery, a conductive material (Super P), and a binder (PVDF) in a ratio of 90:5:5 in an NMP (N-methyl-2-pyrrolidone) solvent, and adjusting the slurry viscosity. The prepared slurry was coated on a 15 μm-thick Al foil using a doctor blade, dried, followed by drying and rolling. The electrode loading amount was about 10 mg/cm² or more, the rolling density was about 2 g/cm³ or more. As the electrolyte solution, 1M LiPF₆ was dissolved in a mixed solvent of EC:DMC:EMC=3:4:3 (vol %), and then 1.5 wt % of vinylene carbonate (VC) was added. After preparing a coin-type half-cell using a PP separator and a lithium negative electrode (200 μm, Honzo metal), it was aged at room temperature for hours. The measurement voltage range was 3.65 V to 2.5 V, and the evaluation was conducted with a 1C standard capacity of 150 mAh/g.

A charge/discharge test was conducted using the prepared coin-type half-cells, and the results of the charge/discharge test of the coin half-cells using the olivine-based positive electrode active materials for a lithium secondary battery according to Examples 1 to 5 and Comparative Examples 1 to 4 are summarized in Table 3 below.

TABLE 3

| | Charge | Discharge | Discharge | High-temperature |
|---|---|---|---|---|
| | capacity | capacity | capacity | life retention |
| | (mAh/ | (mAh/ | (mAh/ | (%) (45° C. |
| | g@0.1 C) | g@0.1 C) | g@1 C) | @1 C, 50 times) |
| Example 1 | 156.5 | 155.8 | 146.1 | 98.2 |
| Example 2 | 156.3 | 155.7 | 146.2 | 98.3 |
| Example 3 | 156.8 | 155.7 | 146 | 98.5 |
| Comparative | 148.3 | 141.5 | 88.2 | 88.2 |
| Example 1 | | | | |
| Comparative | 151.2 | 147.5 | 138.2 | 94.2 |
| Example 2 | | | | |
| Example 4 | 156.6 | 155.8 | 146.2 | 98.2 |
| Example 5 | 156.5 | 155.8 | 146.3 | 98.1 |
| Comparative | 138.2 | 128.3 | 78.3 | 70.2 |
| Example 3 | | | | |
| Comparative | 142.3 | 125.2 | 80.2 | 71.2 |
| Example 4 | | | | |

Referring to Table 3 above, it can be confirmed that the coin half-cells employing the olivine-based positive electrode active materials for a lithium secondary battery according to Examples 1 to 5 exhibited higher charge and discharge capacities and superior high-temperature life characteristics during charge and discharge cycling, as compared to the coin half-cells employing the olivine-based positive electrode active materials for a lithium secondary battery according to Comparative Examples 1 to 4.

It will be understood by one skilled in the art to which the present invention belongs that the present invention is not limited to the above embodiments, but can be manufactured in a variety of different forms, and can be implemented in other specific forms without changing the technical spirit or essential features of the present invention. Therefore, the embodiments described above should be understood as illustrative in all respects and not for purposes of limitation.

1. An olivine-based positive electrode active material for a lithium secondary battery comprising:
a core portion; and
a carbon coating layer positioned on a surface of the core portion, wherein. Relational Expression 1 is satisfied,
$$13. < C \% \times BET / m < 40. \qquad [ Relational Expression 1 ]$$
in Relational Expression 1, C % is a weight percentage (%) of the carbon coating layer, BET is a specific surface area of the olivine-based positive electrode active material for a lithium secondary battery, and m is a tap density of the olivine-based positive electrode active material for a lithium secondary battery.

2. The olivine-based positive electrode active material of claim 1, wherein:
the core portion is represented by Chemical Formula 1,
Liₓ(Fe_{y}M_{1-y})PO₄. [Chemical Formula 1]
where 0.9≤x≤1.3, 0.89≤y≤1.34, 0.99≤x/y≤1.03.

3. The olivine-based positive electrode active material of claim 1, wherein:
the carbon coating layer is included in a range of 1.0 wt % to 2.5 wt % based on a total weight of the core portion and the carbon coating layer.

4. The olivine-based positive electrode active material of claim 1, wherein:
a specific surface area of the olivine-based positive electrode active material for a lithium secondary battery is in a range of 10.0 m²/g to 30.0 m²/g.

5. The olivine-based positive electrode active material of claim 1, wherein:
a tap density of the above olivine-based positive electrode active material for a lithium secondary battery is in a range of 1.0 g/cm³ to 1.15 g/cm³.

6. The olivine-based positive electrode active material of claim 1, wherein:
the olivine-based positive electrode active material for a lithium secondary battery comprises secondary particles formed by agglomeration of primary particles having an average particle size (D50) in a range of 100 nm to 200 nm.

7. The olivine-based positive electrode active material of claim 1, wherein:
an average thickness of the coating layer is in a range of 5 nm to 15 nm.

8. The olivine-based positive electrode active material of claim 6, wherein:
an average particle size (D50) of the secondary particles is in a range of 1.0 μm to 3.0 μm.

9. A method for manufacturing an olivine-based positive electrode active material for a lithium secondary battery, the method comprising:
mixing and milling lithium dihydrogen phosphate (LiH₂PO₄), ferric oxide (Fe₂O₃), a carbon additive, a dispersant, and a solvent to obtain a slurry;
spray-drying the slurry to obtain a positive electrode active material precursor; and
firing the positive electrode active material precursor in a reducing atmosphere to obtain an olivine-based positive electrode active material with a carbon coating layer.

10. The method of claim 9, wherein:
in the firing the positive electrode active material precursor in a reducing atmosphere to obtain an olivine-based positive electrode active material with a carbon coating layer,
an olivine-based positive electrode active material satisfying Relational Expression 1 is obtained,
$$13. < C \% \times BET / m < 40. \qquad [ Relational Expression 1 ]$$
in Relational Expression 1, C % is a weight percentage (%) of the carbon coating layer, BET is a specific surface area of the olivine-based positive electrode active material for a lithium secondary battery, and m is a tap density of the olivine-based positive electrode active material for a lithium secondary battery.

11. The method of claim 9, wherein:
in the mixing and milling lithium dihydrogen phosphate (LiH₂PO₄), ferric oxide (Fe₂O₃), a carbon additive, a dispersant, and a solvent to obtain a slurry,
the lithium dihydrogen phosphate (LiH₂PO₄) is mixed in a molar ratio ranging from 1.0 to 4.0 relative to the ferric oxide (Fe₂O₃).

12. The method of claim 9, wherein:
in the mixing and milling lithium dihydrogen phosphate (LiH₂PO₄), ferric oxide (Fe₂O₃), a carbon additive, a dispersant, and a solvent to obtain a slurry,
an average particle size (D50) of ferric oxide (Fe₂O₃) in the obtained slurry is in a range of 500 nm to 1 μm.

13. The method of claim 9, wherein:
the carbon additive is one or more selected from glucose, sucrose, fructose, lactose, and maltose.

14. The method of claim 9, wherein:
the carbon additive is mixed in a range of 9 wt % to 13 wt % based on a weight of the ferric oxide (Fe₂O₃).

15. The method of claim 9, wherein:
the dispersant is one or more selected from citric acid, fumaric acid, adipic acid, succinic acid, tartaric acid, glutaric acid, maleic acid, oxalic acid, malonic acid, and ascorbic acid.

16. The method of claim 9, wherein:
the dispersant is mixed in a range of 4 wt % to 6 wt % based on a weight of the ferric oxide (Fe₂O₃).

17. The method of claim 9, further comprising,
after the firing the positive electrode active material precursor in a reducing atmosphere to obtain an olivine-based positive electrode active material with a carbon coating layer,
mixing the obtained olivine-based positive electrode active material with a carbon additive and firing the mixture in the reducing atmosphere.
